(19) United States
(12) Patent Application Publication
(10) Pub. No.: US 2025/0067457 A1
(43) Pub. Date: Feb. 27, 2025

(54) SATISFACTION CALCULATION DEVICE, SATISFACTION CALCULATION METHOD, AND COMPUTER READABLE MEDIUM

(71) Applicants: Mitsubishi Electric Corporation, Tokyo (JP); WASEDA UNIVERSITY, Tokyo (JP)

(72) Inventors: Kazuki HAMADA, Tokyo (JP); Noriko TAKAHASHI, Tokyo (JP); Masanori HASHIMOTO, Tokyo (JP); Shinichi TANABE, Tokyo (JP); Hiroaki NAGASHIMA, Tokyo (JP); Yuta FUKAWA, Tokyo (JP)

(73) Assignees: Mitsubishi Electric Corporation, Tokyo (JP); WASEDA UNIVERSITY, Tokyo (JP)

(21) Appl. No.: 18/944,070

(22) Filed: Nov. 12, 2024

Related U.S. Application Data
(63) Continuation of application No. PCT/JP2022/022694, filed on Jun. 3, 2022.

(51) Int. Cl. F24F 11/64; F24F 11/52; F24F 110/10; F24F 110/20; F24F 110/70; F24F 140/60

(52) U.S. Cl. CPC F24F 11/64; F24F 11/52; F24F 2110/10; F24F 2110/20; F24F 2110/70; F24F 2140/60

(57) ABSTRACT

A satisfaction calculation device (10) calculates satisfaction with an air quality expressing an air environment of a space. A specific enthalpy calculation unit (110) acquires a temperature and a humidity of the space and calculates a specific enthalpy of the space. An air quality satisfaction calculation unit (120) acquires a carbon dioxide concentration of the space, decides a constant that takes a different value in accordance with the carbon dioxide concentration, and calculates satisfaction with the air quality as an air quality satisfaction (31) by using the specific enthalpy and the constant. The air quality satisfaction calculation unit (120) calculates, as the air quality satisfaction (31), a value obtained by adding a second constant to a value obtained by multiplying the specific enthalpy by a first constant.

### CROSS REFERENCE TO RELATED APPLICATIONS

This application is a Continuation of PCT International Application No. PCT/JP2022/022694 filed on Jun. 3, 2022, all of which is hereby expressly incorporated by reference into the present application.

### TECHNICAL FIELD

The present disclosure relates to a satisfaction calculation device, a satisfaction calculation method, and a satisfaction calculation program. In particular, the present disclosure relates to a satisfaction calculation device, a satisfaction calculation method, and a satisfaction calculation program which calculate satisfaction with an air quality environment of a space.

### BACKGROUND ART

In recent years, for a device such as an air-conditioning apparatus and a ventilation apparatus which controls an environment of a building, a method of calculating a user satisfaction related to the quality of air has been proposed.

Patent Literature 1 discloses a technique of calculating an amenity index from a weighted value of a carbon dioxide concentration and a discomfort index which is determined from a temperature and a humidity.

### CITATION LIST

### Patent Literature

Patent Literature 1: JP 2011-089682 A

### SUMMARY OF INVENTION

### Technical Problem

In Patent Literature 1, an amenity index is calculated from a weighted value of a carbon dioxide concentration and a discomfort index which is determined from a temperature and a humidity. However, the calculated amenity index does not serve to evaluate qualitative information expressing how much a user who uses the space is satisfied with air quality of the space. Therefore, how to quantitatively evaluate the qualitative information expressing satisfaction with the air quality remains as an issue.

The present disclosure has as its objective to calculate and evaluate qualitative information which is user's satisfaction with an air environment of a space, as a quantitative index.

### Solution to Problem

A satisfaction calculation device according to the present disclosure calculates satisfaction with an air quality expressing an air environment of a space, the satisfaction calculation device including:
a specific enthalpy calculation unit to acquire a temperature and a humidity of the space and to calculate a specific enthalpy of the space; and
an air quality satisfaction calculation unit to acquire a carbon dioxide concentration of the space, to decide a constant that takes a different value in accordance with the carbon dioxide concentration, and to calculate satisfaction with the air quality as an air quality satisfaction by using the specific enthalpy and the constant.

### Advantageous Effects of Invention

In a satisfaction calculation device according to the present disclosure, an air quality satisfaction calculation unit determines a constant in accordance with a carbon dioxide concentration of a space, and calculates satisfaction with an air quality as an air quality satisfaction, with using a specific enthalpy in the space and the constant.

Therefore, the satisfaction calculation device according to the present disclosure has an effect of being able to calculate qualitative information expressing satisfaction with the air quality, as a quantitative index.

### BRIEF DESCRIPTION OF DRAWINGS

FIG. 1 is a diagram illustrating a configuration example of a satisfaction calculation system according to Embodiment 1.

FIG. 2 is a diagram illustrating a configuration example of a satisfaction calculation device according to Embodiment 1.

FIG. 3 is a flowchart illustrating an operation example of the satisfaction calculation device according to Embodiment 1.

FIG. 4 is a diagram illustrating a configuration example of a satisfaction calculation device according to a modification of Embodiment 1.

FIG. 5 is a diagram illustrating a configuration example of a satisfaction calculation system according to Embodiment 2.

FIG. 6 is a diagram illustrating a configuration example of a satisfaction calculation device according to Embodiment 2.

FIG. 7 is a flowchart illustrating an operation example of the satisfaction calculation device according to Embodiment 2.

FIG. 8 is a flowchart illustrating an operation example of processes of accumulating control information and power consumption information to a storage unit according to Embodiment 2.

FIG. 9 is a diagram illustrating a configuration example of a satisfaction calculation system according to Embodiment 3.

FIG. 10 is a diagram illustrating a configuration example of a satisfaction calculation device according to Embodiment 3.

FIG. 11 is a flowchart illustrating an operation example of the satisfaction calculation device according to Embodiment 3.

### DESCRIPTION OF EMBODIMENTS

### Embodiment 1

### Description of Configuration

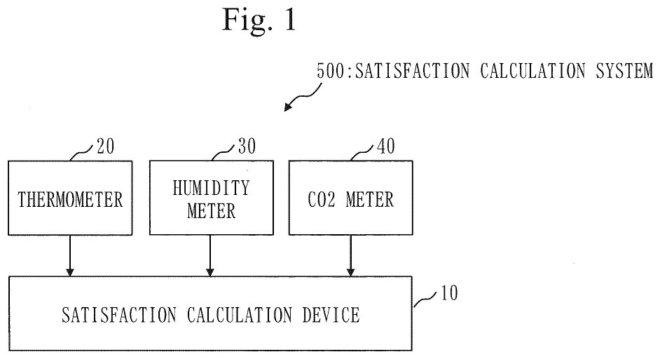

FIG. 1 is a diagram illustrating a configuration example of a satisfaction calculation system 500 according to the present embodiment.

The satisfaction calculation system 500 according to the present embodiment is provided with a satisfaction calculation device 10, a thermometer 20, a humidity meter 30, and a CO2 meter 40. The individual devices, that is, the thermometer 20, the humidity meter 30, and the CO2 meter 40, are sometimes called measurement sensors.

The satisfaction calculation system 500 calculates satisfaction with an air quality environment of a space by cooperation of the satisfaction calculation device 10, the thermometer 20, the humidity meter 30, and the CO2 meter 40. The satisfaction calculation system 500 is also called air quality satisfaction calculation system.

The thermometer 20 has a function of measuring a temperature of a space, that is, a room temperature.

The humidity meter 30 has a function of measuring a humidity of the space.

The CO2 meter 40 has a function of measuring a carbon dioxide concentration of the space.

The satisfaction calculation device 10 has a function of calculating satisfaction with an air quality expressing an air environment of the space. The satisfaction calculation device 10 is also called air quality satisfaction calculation device.

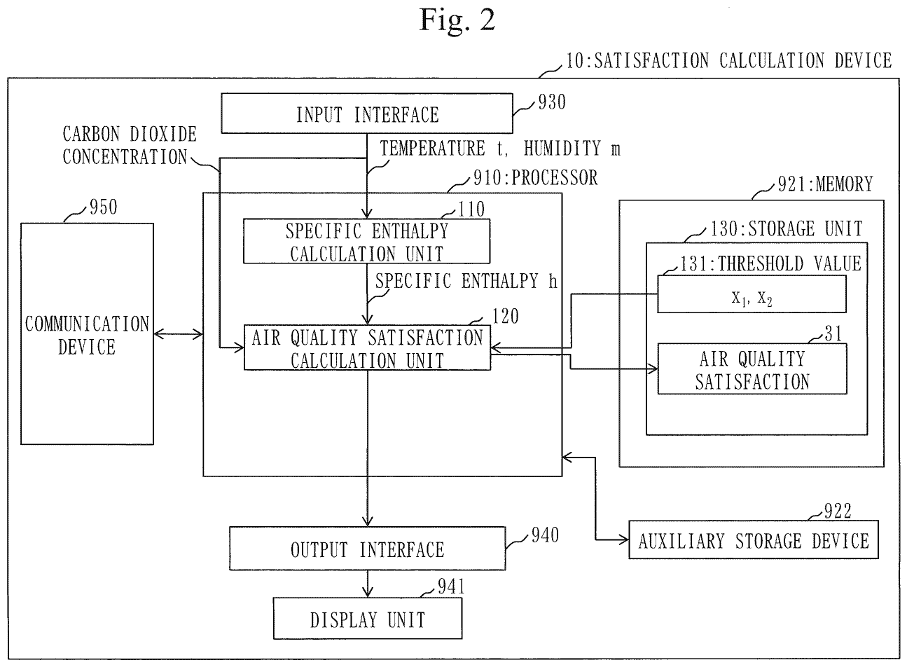

FIG. 2 is a diagram illustrating a configuration example of the satisfaction calculation device 10 according to the present embodiment.

The satisfaction calculation device 10 is a computer. The satisfaction calculation device 10 is provided with a processor 910, and is also provided with other hardware devices such as a memory 921, an auxiliary storage device 922, an input interface 930, an output interface 940, and a communication device 950. The processor 910 is connected to the other hardware devices via a signal line and controls the other hardware devices.

The satisfaction calculation device 10 is provided with a specific enthalpy calculation unit 110, an air quality satisfaction calculation unit 120, and a storage unit 130, as function elements. The storage unit 130 stores a first threshold value x₁ and a second threshold value x₂, as a threshold value 131, and an air quality satisfaction 31.

Functions of the specific enthalpy calculation unit 110 and air quality satisfaction calculation unit 120 are implemented by software. The storage unit 130 is provided to the memory 921. Note that the storage unit 130 may be provided to the auxiliary storage device 922, or may be provided to the memory 921 and the auxiliary storage device 922 by distribution.

The processor 910 is a device that runs a satisfaction calculation program. The satisfaction calculation program is a program that implements the functions of the specific enthalpy calculation unit 110 and air quality satisfaction calculation unit 120.

The processor 910 is an IC that performs computation processing. Specific examples of the processor 910 are a CPU, a DSP, and a GPU. Note that IC stands for Integrated Circuit; CPU for Central Processing Unit; DSP for Digital Signal Processor; and GPU for Graphics Processing Unit.

The memory 921 is a device that stores data temporarily. A specific example of the memory 921 is an SRAM or a DRAM. Note that SRAM stands for Static Random-Access Memory; and DRAM for Dynamic Random-Access Memory.

The auxiliary storage device 922 is a storage device that keeps data. A specific example of the auxiliary storage device 922 is an HDD. Alternatively, the auxiliary storage device 922 may be a portable storage medium such as an SD (registered trademark) memory card, a CF, a NAND flash, a flexible disk, an optical disk, a compact disk, a Blu-ray (registered trademark) disc, and a DVD. Note that HDD stands for Hard Disk Drive; SD (registered trademark) for Secure Digital; CF for CompactFlash (registered trademark); and DVD for Digital Versatile Disk.

The input interface 930 is a port to be connected to an input device such as a mouse, a keyboard, and a touch panel. The input interface 930 is specifically a USB terminal. Alternatively, the input interface 930 may be a port to be connected to a LAN. Note that USB stands for Universal Serial Bus; and LAN for Local Area Network.

The input interface 930 is connected to the individual measurement sensors, that is, the thermometer 20, the humidity meter 30, and the CO2 meter 40. The input interface 930 has a role of a measurement sensor interface which acquires sensor data acquired by the individual measurement sensors, that is, the thermometer 20, the humidity meter 30, and the CO2 meter 40.

The output interface 940 is a port to which a cable of a display unit 941 such as a display is to be connected. The output interface 940 is specifically a USB terminal, an HDMI (registered trademark) interface, or a VGA interface. The display is specifically an LCD. The output interface 940 has a role of a display unit interface or a video output interface.

For example, the satisfaction calculation device 10 displays the calculated air quality satisfaction 31 to the display via the output interface 940.

Note that HDMI (registered trademark) stands for High Definition Multimedia Interface; VGA for Video Graphic Array; and LCD for Liquid Crystal Display.

The communication device 950 has a receiver and a transmitter. The communication device 950 is connected to a communication network such as a LAN, the Internet, and a telephone line. The communication device 950 is specifically a communication chip or an NIC. Note that the communication device 950 may have a role of a communication interface which acquires the sensor data acquired by the measurement sensors, that is, the thermometer 20, the humidity meter 30, and the CO2 meter 40, in a wired manner or a wireless manner. Note that NIC stands for Network Interface Card.

The satisfaction calculation program is run in the satisfaction calculation device 10. The satisfaction calculation program is read by the processor 910 and run by the processor 910. The memory 921 stores not only the satisfaction calculation program but also an OS. Note that OS stands for Operating System. The processor 910 runs the satisfaction calculation program while running the OS. The satisfaction calculation program and the OS may be stored in the auxiliary storage device 922. The satisfaction calculation program and the OS stored in the auxiliary storage device 922 are loaded to the memory 921 and run by the processor 910. Note that the satisfaction calculation program may be incorporated in the OS partly or entirely.

The satisfaction calculation device 10 may be provided with a plurality of processors that substitute for the processor 910. The plurality of processors run the satisfaction calculation program in a shared manner. Each processor is a device that runs the satisfaction calculation program just as the processor 910 does.

Data, information, signal values, and variable values which are utilized, processed, or outputted by the satisfaction calculation program are stored in the memory 921, the auxiliary storage device 922, or a register or cache memory in the processor 910.

The word “unit” in “specific enthalpy calculation unit 110” and “air quality satisfaction calculation unit 120” may be replaced with “circuit”, “stage”, “procedure”, “process”, or “circuitry”. The satisfaction calculation program causes the computer to execute a specific enthalpy calculation process and an air quality satisfaction calculation process. The word “process” in “specific enthalpy calculation process” and “air quality satisfaction calculation process” may be replaced with “program”, “program product”, “program-stored computer readable storage medium”, or “program-recorded computer readable recording medium”. Also, a satisfaction calculation method is a method that is practiced by the satisfaction calculation device 10 running the satisfaction calculation program.

The satisfaction calculation program may be provided as being stored in a computer readable recording medium. The satisfaction calculation program may be provided in the form of a program product.

### Description of Operations

Next, operations of the satisfaction calculation device 10 according to the present embodiment will be described. An operation procedure of the satisfaction calculation device 10 corresponds to the satisfaction calculation method. Also, a program that implements the operations of the satisfaction calculation device 10 corresponds to the satisfaction calculation method.

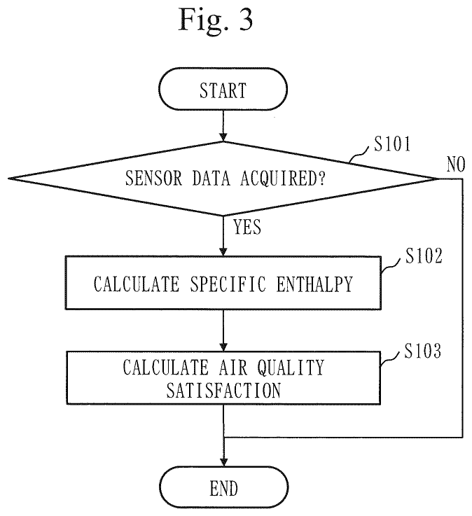

FIG. 3 is a flowchart illustrating an operation example of the satisfaction calculation device 10 according to the present embodiment.

### <Measurement Data Acquisition Process: Step S101>

The input interface 930 acquires sensor data acquired by the individual sensors, that is, the thermometer 20, the humidity meter 30, and the CO2 meter 40. The sensor data includes a value of the temperature, a value of the humidity, and a value of the carbon dioxide concentration.

If it is determined that the input interface 930 has not acquired sensor data, the processing ends.

### <Specific Enthalpy Calculation Process: Step S102>

The specific enthalpy calculation unit 110 acquires a temperature and a humidity of the space via the input interface 930. The specific enthalpy calculation unit 110 calculates a specific enthalpy h of the space by using the temperature and humidity of the space.

Specifically, the specific enthalpy calculation unit 110 takes the temperature and humidity measured by the thermometer 20 and humidity meter 30 as input values, and calculates the specific enthalpy h. The specific enthalpy h is, according to a physical definition, calculated by the following Expression 1 using a temperature t (° C.) and an absolute humidity m (Kg/kg′).

$$( Specific Enthalpy ) - h = 1.006 * t + ( 1.8 56 t + 25 \; 01 ) * m \qquad ( Expression 1 )$$

Some humidity meter has a function of measuring an absolute humidity. Hence, it is preferable to employ, as the humidity meter 30, a humidity meter having a function of measuring an absolute humidity.

A more general humidity meter has a function of measuring a relative humidity only. When using a humidity meter that can measure a relative humidity only, an absolute humidity can be calculated from a relative humidity by further measuring an air pressure, or by assuming an atmospheric pressure (for example, 1 atmospheric pressure=1013 Pa). In this manner, it is also possible to use a humidity meter that can measure a relative humidity only.

### <Air Quality Satisfaction Calculation Process: Step S103>

First, the air quality satisfaction calculation unit 120 acquires a carbon dioxide concentration of the space and decides constants a and b each of which takes a different value in accordance with the carbon dioxide concentration. Then, the air quality satisfaction calculation unit 120 calculates satisfaction with an air quality as the air quality satisfaction 31 by using the specific enthalpy h and the constants a and b.

This is specifically as follows.

The air quality satisfaction calculation unit 120 calculates the air quality satisfaction 31 with using the specific enthalpy h calculated by the specific enthalpy calculation unit 110, and the carbon dioxide concentration measured by the CO2 meter 40.

The air quality satisfaction 31 is a value that expresses satisfaction with the air quality representing an atmospheric environment of a space being a target for which an air quality satisfaction is to be calculated. The air quality satisfaction 31 is also called air quality environment satisfaction. In the following, the air quality satisfaction 31 is defined as air quality satisfaction S.

An experimental approach using a subject reveals that the air quality satisfaction S can be calculated by the following Expression 2 which is a function expression using the specific enthalpy h as a variable.

$$Air Quality Satisfaction S = a * h + b \qquad ( Expression 2 )$$

a, b: constant

Different values are used as the constants a and b in accordance with the carbon dioxide concentration. Specifically, the values of a and b are decided by the following expressions.
(i) When carbon dioxide concentration <x₁ ppm: then, a=a₁, b=b₁
(ii) When x₁ ppm≤carbon dioxide concentration <x₂ ppm: then, a=a₂, b=b₂
(iii) When x₂ ppm≤carbon dioxide concentration: then, a=a₃, b=b₃

According to the experiment result, the best result can be obtained when x₁=600 and x₂=900. It has been revealed that at this time, approximately a=−1.0±0.5 and b=125±25 are suitable.

Note that the values of x₁ and x₂ and the values of a and b are not limited to those mentioned above.

The above example of the air quality satisfaction calculation process will be summarized as follows.

The satisfaction calculation device 10 stores a first threshold value x₁ and a second threshold value x₂ in the storage unit 130, as the threshold value 131 of the carbon dioxide concentration.

The air quality satisfaction calculation unit 120 decides the first constant a and the second constant b in accordance with which case the carbon dioxide concentration corresponds to, among: a case where the carbon dioxide concentration is lower than the first threshold value; a case where the carbon dioxide concentration is equal to or higher than the first threshold value and lower than the second threshold value; and a case where the carbon dioxide concentration is equal to or higher than the second threshold value.

As described above, the air quality satisfaction calculation unit 120 decides, as the constant, the first constant a by which the specific enthalpy is to be multiplied, and the second constant b which is to be added to a value obtained by multiplying the specific enthalpy h by the first constant a. The air quality satisfaction calculation unit 120 calculates, as the air quality satisfaction S, a value obtained by adding the second constant b to the value obtained by multiplying the specific enthalpy h by the first constant a.

### Explanation of Effect of Present Embodiment

As described above, the satisfaction calculation system according to the present embodiment achieves an effect of being able to calculate qualitative information expressing the satisfaction with the air quality environment, as a quantitative index by using the carbon dioxide concentration, and the specific enthalpy calculated from the temperature and humidity.

### Other Configurations

### Modification 1

The satisfaction calculation device 10 may display on the display unit 941 a display screen showing the air quality satisfaction S, via the output interface 940.

The satisfaction calculation device 10 may display the air quality satisfaction S onto an external display device via a video output interface.

It should be noted that the storage unit 130 accumulates a history of the air quality satisfaction S calculated by the air quality satisfaction calculation unit 120. The satisfaction calculation device 10 may visualize progress of the air quality satisfaction S with a format such as a graph or table, and may display the visualized progress to the display unit 941 or an external display device.

### Modification 2

In the present embodiment, the functions of the specific enthalpy calculation unit 110 and air quality satisfaction calculation unit 120 are implemented by software. A modification may be possible in which the functions of the specific enthalpy calculation unit 110 and air quality satisfaction calculation unit 120 are implemented by hardware.

Specifically, the satisfaction calculation device 10 is provided with an electronic circuit 909 in place of the processor 910.

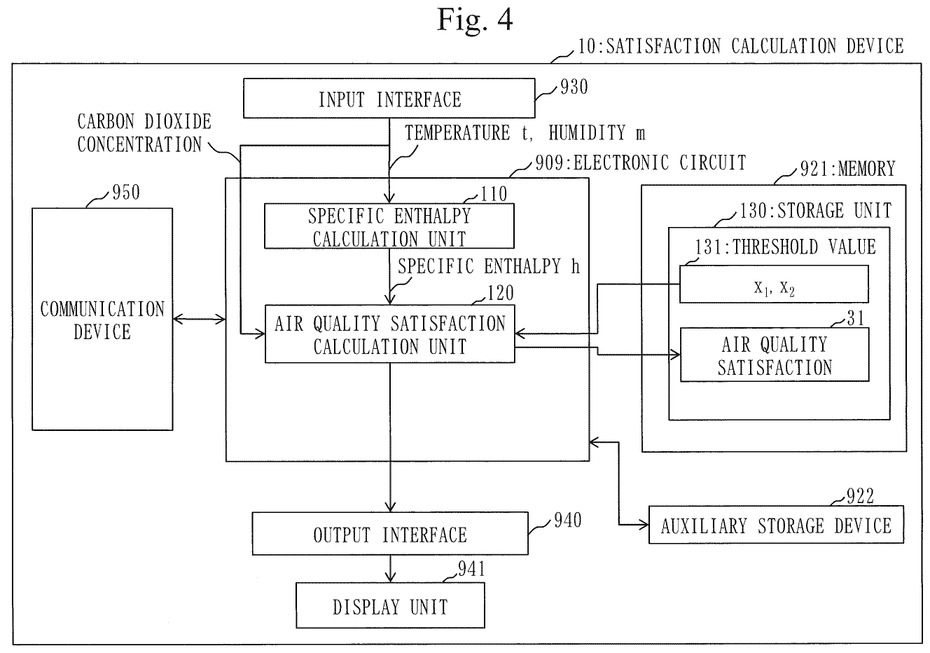

FIG. 4 is a diagram illustrating a configuration example of the satisfaction calculation device 10 according to the modification of the present embodiment.

The electronic circuit 909 is a dedicated electronic circuit that implements the functions of the specific enthalpy calculation unit 110 and air quality satisfaction calculation unit 120. The electronic circuit 909 is specifically a single circuit, a composite circuit, a programmed processor, a parallel-programmed processor, a logic IC, a GA, an ASIC, or an FPGA. Note that GA stands for Gate Array; ASIC for Application Specific Integrated Circuit; and FPGA for Field-Programmable Gate Array.

The functions of the specific enthalpy calculation unit 110 and air quality satisfaction calculation unit 120 may be implemented by one circuit, or may be implemented by a plurality of electronic circuits by distribution.

The electronic circuit may be a dedicated circuit that implements the functions of the individual function elements and the functions of the memory 921 and auxiliary storage device 922.

Another modification may be possible in which some of the functions of the specific enthalpy calculation unit 110 and air quality satisfaction calculation unit 120 are implemented by an electronic circuit and the remaining functions are implemented by software. Some or all of the functions of the specific enthalpy calculation unit 110 and air quality satisfaction calculation unit 120 may be implemented by firmware.

The processor and the electronic circuit are also called processing circuitry. That is, the functions of the specific enthalpy calculation unit 110 and air quality satisfaction calculation unit 120 are implemented by processing circuitry.

### Embodiment 2

In the present embodiment, differences from Embodiment 1 and additional features to Embodiment 1 will mainly be described.

In the present embodiment, a configuration having the same function as that in Embodiment 1 will be denoted by the same reference sign as in Embodiment 1, and its description will be omitted.

### Description of Configuration

In the present embodiment, a mode will be described which is provided with a function of controlling an air conditioner and a ventilator on a basis of the air quality satisfaction 31 which is a calculation result of a satisfaction calculation device 10, in addition to the functions of the satisfaction calculation system 500 disclosed in Embodiment 1.

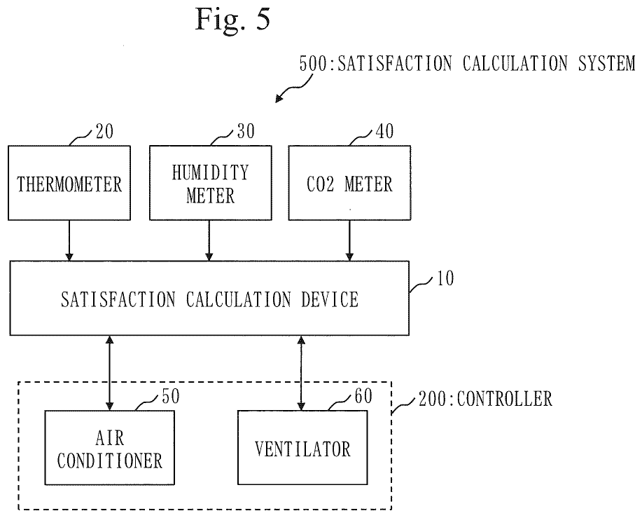

FIG. 5 is a diagram illustrating a configuration example of a satisfaction calculation system 500 according to the present embodiment.

The satisfaction calculation system 500 according to the present embodiment is provided with a controller 200 which has an influence on the air quality, in addition to the configuration described in Embodiment 1. The controller 200 includes an air conditioner 50 and a ventilator 60.

Each of the air conditioner 50 and the ventilator 60 has an interface with a satisfaction calculation device 10. Each of the air conditioner 50 and the ventilator 60 has a function of changing a control content in accordance with a control instruction 35 from the satisfaction calculation device 10. The air conditioner 50 and the ventilator 60 also have a function of notifying the satisfaction calculation device 10 of control information of the air conditioner 50 and the ventilator 60, respectively. Note that in each of the air conditioner 50 and the ventilator 60, the interface with the satisfaction calculation device 10 need not be a dedicated interface. As the interface with the satisfaction calculation device 10, for example, an existing interface used for exchanging information with another device such as an air-conditioner remote controller may be used.

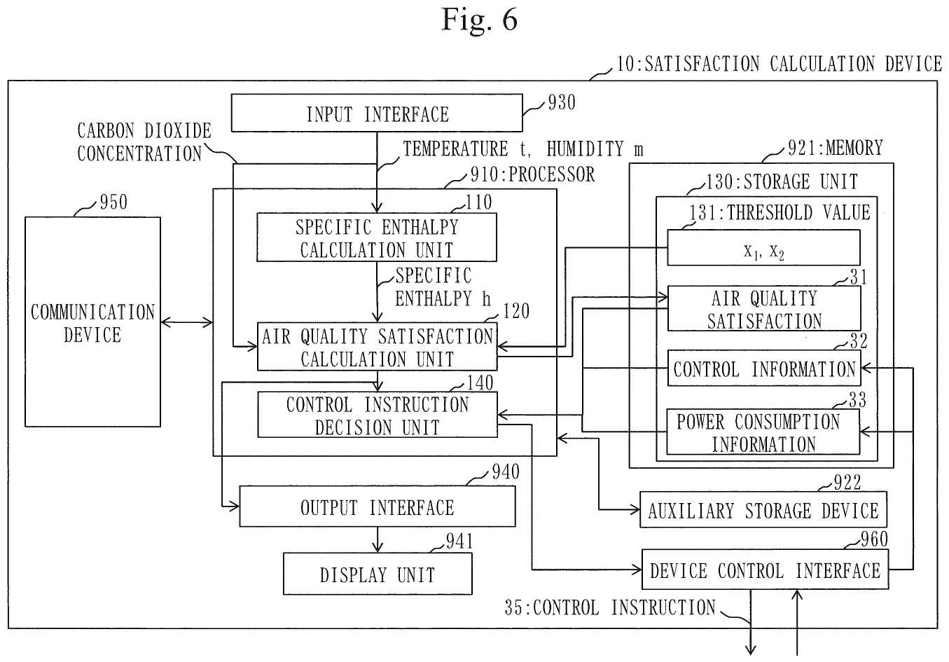

FIG. 6 is a diagram illustrating a configuration example of the satisfaction calculation device 10 according to the present embodiment.

The satisfaction calculation device 10 has a device control interface 960 in addition to the configuration described in Embodiment 1. The device control interface 960 acquires control information and power consumption information transmitted from each of the air conditioner 50 and the ventilator 60. The input interface 930 or the communication device 950 may have a function of the device control interface 960.

The satisfaction calculation device 10 has a control instruction decision unit 140 in addition to the function elements described in Embodiment 1. Also, the satisfaction calculation device 10 stores control information 32 and power consumption information 33 in a storage unit 130, in addition to the threshold value 131 and the air quality satisfaction 31 described in Embodiment 1. The functions of the satisfaction calculation device 10 according to the present embodiment are similarly implemented by software or hardware just as the functions described in Embodiment 1 are.

### Description of Operations

Next, operations of the satisfaction calculation device 10 according to the present embodiment will be described. An operation procedure of the satisfaction calculation device 10 corresponds to a satisfaction calculation method. A program that implements the operations of the satisfaction calculation device 10 corresponds to a satisfaction calculation program.

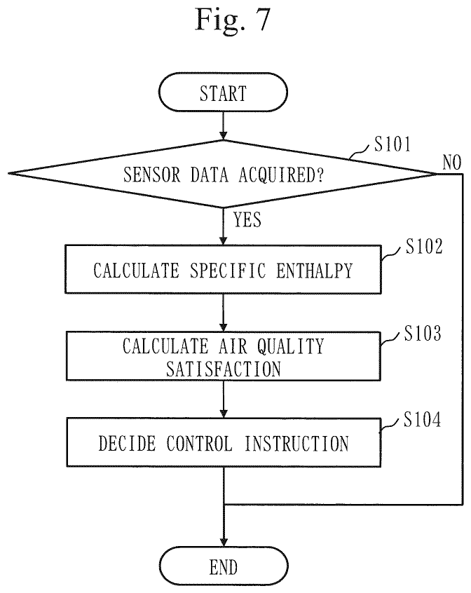

FIG. 7 is a flowchart illustrating an operation example of the satisfaction calculation device 10 according to the present embodiment.

Processes of step S101 to step S103 in FIG. 7 are the same as the processes of step S101 to step S103 in FIG. 3.

### <Control Instruction Decision Process: Step S104>

The control instruction decision unit 140 decides the control instruction 35 to change control for the controller 200 which influences the air quality, on a basis of the air quality satisfaction 31.

The storage unit 130 stores a history of the control information 32 in the controller 200, a history of the air quality satisfaction 31, and a history of the power consumption information 33 in the controller 200.

The control instruction decision unit 140 estimates a change amount of the air quality satisfaction 31 caused by the control instruction 35, and a power consumption increase caused by the control instruction 35, by using the history of the control information 32, the history of the air quality satisfaction 31, and the history of the power consumption information 33. Then, the control instruction decision unit 140 decides a control content that can be achieved with the smallest power consumption increase, as the control instruction 35, among control contents that improve the air quality satisfaction 31 from a current state.

Following is a specific example of deciding the control instruction 35.

The control instruction decision unit 140 reads out the individual histories of the air quality satisfaction 31, control information 32, and power consumption information 33 which are stored in the storage unit 130.

The control instruction decision unit 140 determines whether or not it is necessary to perform control for increasing the air quality satisfaction 31. Specifically, the control instruction decision unit 140 compares the present air quality satisfaction 31 and the predetermined threshold value of the air quality satisfaction so as to determine whether or not it is necessary to perform control for increasing the air quality satisfaction 31.

When it is determined that it is necessary to perform control for increasing the air quality satisfaction 31, the control instruction decision unit 140 decides control for increasing the air quality satisfaction 31 for the air conditioner 50 and the ventilator 60, as the control instruction 35. Then, the control instruction decision unit 140 requests the air conditioner 50 and the ventilator 60 to comply with the control instruction 35.

Control for increasing the air quality satisfaction 31 may have been determined to be necessary in the past and the control instruction 35 may have actually been executed in the controller 200. In such a case, when it is determined that the air quality satisfaction 31 has increased sufficiently, the control instruction decision unit 140 ends request of the control instruction 35 currently under execution.

The control instruction decision unit 140 decides the control instruction 35 as follows.

The control instruction 35 includes one, or a combination, of: an instruction to change control of the air conditioner 50 so that the specific enthalpy h decreases; and an instruction to increase a ventilation quantity of the ventilator 60 so that the carbon dioxide concentration decreases. Also, it is preferable that a method capable of implementing these controls with as little increase in power consumption as possible be selected as the control instruction 35.

The control instruction decision unit 140 estimates an increase in power consumption occurring due to change of the control by the control instruction 35, by comparing the history of the control information 32 with the history of the power consumption information 33. Then, the control instruction decision unit 140 decides a control that can be achieved with the smallest power consumption increase, as the control instruction 35, among controls that improve the air quality satisfaction 31 from a current state.

Following is another specific example of deciding the control instruction 35.

The storage unit 130 may store the history of the control information 32 in the controller 200 and the history of the air quality satisfaction 31, and may hold information of the power consumption in accordance with the control content of the controller 200 in advance.

In such a case, the control instruction decision unit 140 estimates a change amount of the air quality satisfaction 31 resulting from control by the controller 200, from the history of the control information 32 and the history of the air quality satisfaction 31, per control content for the controller 200. Then, the control instruction decision unit 140 decides a control content that can be achieved with the smallest power consumption increase, as the control instruction 35, among control contents that improve the air quality satisfaction 31 from the current state by combination of the change amount of the air quality satisfaction 31 with a power consumption of when the control contents are practiced.

For example, if an increase in power consumption due to a change of the control content is already evident from a product catalogue or by another method, a power consumption increase due to the change of the control may be calculated by using information that is already evident.

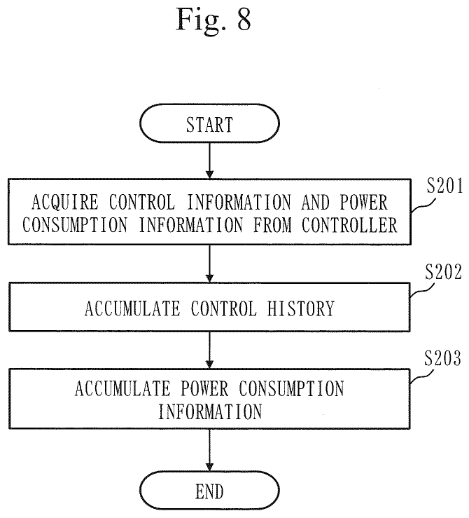

FIG. 8 is a flowchart illustrating an operation example of processes of accumulating the control information 32 and the power consumption information 33 to the storage unit 130 according to the present embodiment.

### <Process of Acquiring Control Information 32 and Power Consumption Information 33: Step S201>

The device control interface 960 acquires, from the air conditioner 50 and the ventilator 60, the control information 32 being information concerning the control states of the air conditioner 50 and ventilator 60, and the power consumption information 33 being information concerning power consumptions of the air conditioner 50 and ventilator 60.

An example of the control information 32 of the air conditioner 50 is information such as the operation mode, preset temperature, and an air quantity in the air conditioner 50. An example of the control information 32 of the ventilator 60 is information such as an air quantity of the ventilator 60 and whether a heat exchange function operates or not.

### <Process of Accumulating Control Information 32: Step S202>

The device control interface 960 accumulates in the storage unit 130 the control information 32 acquired in step S201. Hence, the history of the control information 32 is stored in the storage unit 130.

### <Process of Accumulating Power Consumption Information 33: Step S203>

The device control interface 960 accumulates in the storage unit 130 the power consumption information 33 acquired in step S201. Hence, the history of the power consumption information 33 is stored in the storage unit 130.

As described above, there is a case where an increase in power consumption due to a change of the control content is already evident from a product catalogue or by another method and the power consumption increase can be calculated with using the information that is already evident like this. In such a case, the satisfaction calculation device 10 need not have a function of the power consumption information acquisition process of step S201 and a function of the power consumption information accumulating process of step S203.

### Explanation of Effect of Present Embodiment

As described above, with the satisfaction calculation system according to the present embodiment, the control contents of the air conditioner 50 and ventilator 60 are decided on a basis of the calculation result of the air quality satisfaction, so an improvement of the air quality satisfaction can be implemented with a small power consumption increase.

### Another Configuration

### Modification 3

In a situation where a manipulation is inputted to the controller 200, the satisfaction calculation device 10 may not decide the control instruction 35 for a device to which a manipulation is inputted in the controller 200. The satisfaction calculation device 10 may decide the control instruction 35 only for a device to which a manipulation is not inputted.

The present embodiment has explained that the satisfaction calculation device 10 decides control of the air conditioner 50 and the ventilator 60.

There may be a case where the user inputs a manipulation to the air conditioner 50 or the ventilator 60 via a user manipulation terminal such as a remote controller installed on the wall. Also, there may be a case where an instruction of the control content is inputted from a host controller connected to the air conditioner 50 or the ventilator 60.

In such a case, assume that a device, between the air conditioner 50 and the ventilator 60, that has received a manipulation from the user or a control instruction from the host controller operates in accordance with the inputted manipulation content. The satisfaction calculation device 10 inputs a manipulation necessary for implementing an appropriate air quality satisfaction, to a device, between the air conditioner 50 and the ventilator 60, that has not received a manipulation from the user.

According to this Modification 3, the device is controlled appropriately while a manipulation request inputted from the user via the user manipulation terminal or a manipulation instruction from the host controller is satisfied, so it is possible to provide a space where the air quality satisfaction is improved. Hence, it is possible to decide a control content of a control device for implementing a good air quality satisfaction in the space, without interfering with a manipulation by the user or from another control device.

### Embodiment 3

In the present embodiment, differences from Embodiment 1 or 2 and additional features to Embodiment 1 or 2 will mainly be described.

In the present embodiment, a configuration having the same function as that in Embodiment 1 or 2 will be denoted by the same reference sign as in Embodiment 1 or 2, and its description will be omitted.

### Description of Configuration

A satisfaction calculation system 500 according to the present embodiment is provided with a function of collecting a user's subjective evaluation, in addition to the air quality satisfaction calculation function disclosed in Embodiment 1 or 2. Furthermore, the satisfaction calculation system 500 according to the present embodiment is provided with a function of correcting a calculation result of the air quality satisfaction by taking as an input value the value of the user's subjective evaluation.

The air quality satisfaction 31 calculated in the embodiments described above expresses a human subjective evaluation of an air quality as a quantitative value measured with a fixed measure. Meanwhile, individual evaluation of the air quality may be subject to an individual difference such as a preference for the air quality and sensibility to the air quality. Hence, there is a possibility that when considering each individual or a small group as an evaluation subject, a certain degree of discrepancy will occur between the subjective evaluation that each person or a member of the group holds and the air quality satisfaction 31 calculated in Embodiment 1 or 2.

In the present embodiment, a satisfaction calculation device 10 acquires a subjective evaluation about the air quality satisfaction 31 which is given by a user who utilizes the space, as feedback information. The satisfaction calculation device 10 derives a correction term on a basis of the subjective evaluation and information of a temperature, a humidity, and a carbon dioxide concentration which are measured at the time of the evaluation. Then, the satisfaction calculation device 10 makes air quality satisfaction calculation formula that takes into account this correction term, and uses the calculation formula for calculating the air quality satisfaction 31. Hence, the satisfaction calculation device 10 can calculate an air quality satisfaction 31 that better reflects the subjective air quality satisfaction with the user who uses the space.

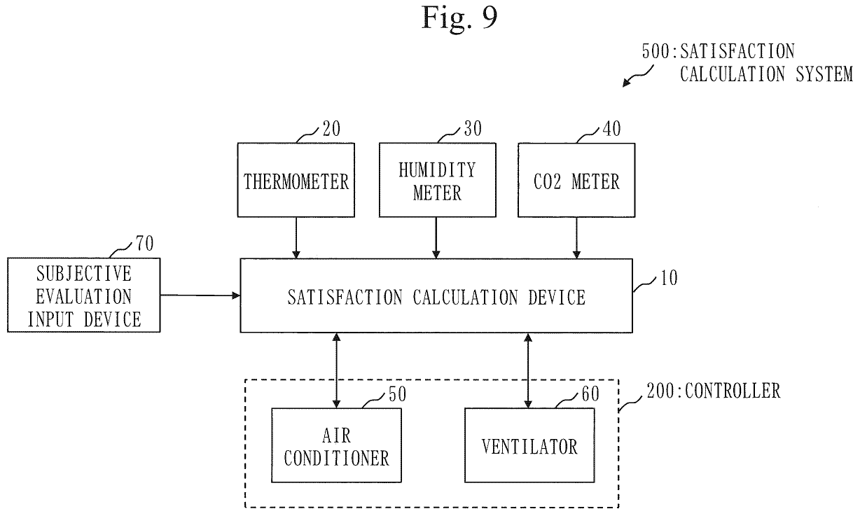

FIG. 9 is a diagram illustrating a configuration example of the satisfaction calculation system 500 according to the present embodiment.

The satisfaction calculation system 500 according to the present embodiment is provided with a subjective evaluation input device 70 in addition to the configuration described in Embodiment 2,

The subjective evaluation input device 70 has an interface for the satisfaction calculation device 10.

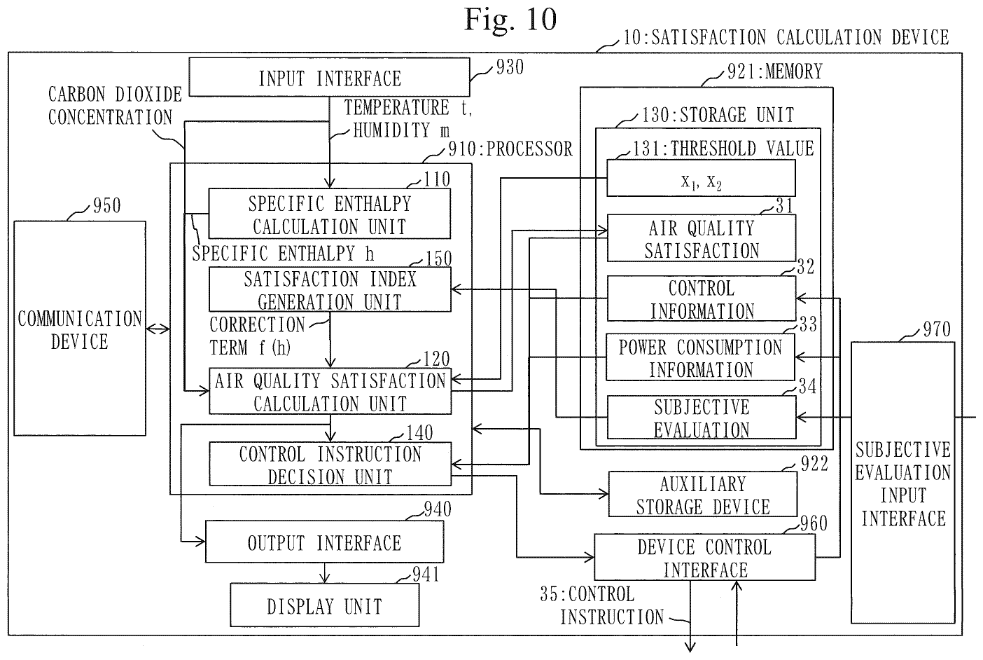

FIG. 10 is a diagram illustrating a configuration example of the satisfaction calculation device 10 according to the present embodiment.

The satisfaction calculation device 10 has a subjective evaluation input interface 970 in addition to the configuration described in Embodiment 2. The subjective evaluation input interface 970 accepts input of a subjective evaluation 34 about the air quality satisfaction. Specifically, the subjective evaluation input interface 970 acquires the subjective evaluation 34 transmitted from the subjective evaluation input device 70 and stores the subjective evaluation 34 to the storage unit 130. An input interface 930 or a communication device 950 may have a function of the subjective evaluation input interface 970.

The satisfaction calculation device 10 also has a satisfaction index generation unit 150 in addition to the function elements described in Embodiment 2. The satisfaction index generation unit 150 generates the correction term used for calculating the air quality satisfaction on a basis of the subjective evaluation 34.

A storage unit 130 stores the subjective evaluation 34 in addition to the information described in Embodiment 2. The functions of the satisfaction calculation device 10 according to the present embodiment are similarly implemented by software or hardware just as the functions described in Embodiment 2 are.

FIGS. 9 and 10 illustrate configurations having the subjective evaluation input interface 970, the satisfaction index generation unit 150, and the subjective evaluation 34 in addition to the configuration of Embodiment 2. However, FIGS. 9 and 10 may illustrate configurations having the subjective evaluation input interface 970, the satisfaction index generation unit 150, and the subjective evaluation 34 in addition to the configuration of Embodiment 1.

### Description of Operations

Operations of the satisfaction calculation device 10 according the present embodiment will now be described. An operation procedure of the satisfaction calculation device 10 corresponds to a satisfaction calculation method. A program that implements the operations of the satisfaction calculation device 10 corresponds to a satisfaction calculation program.

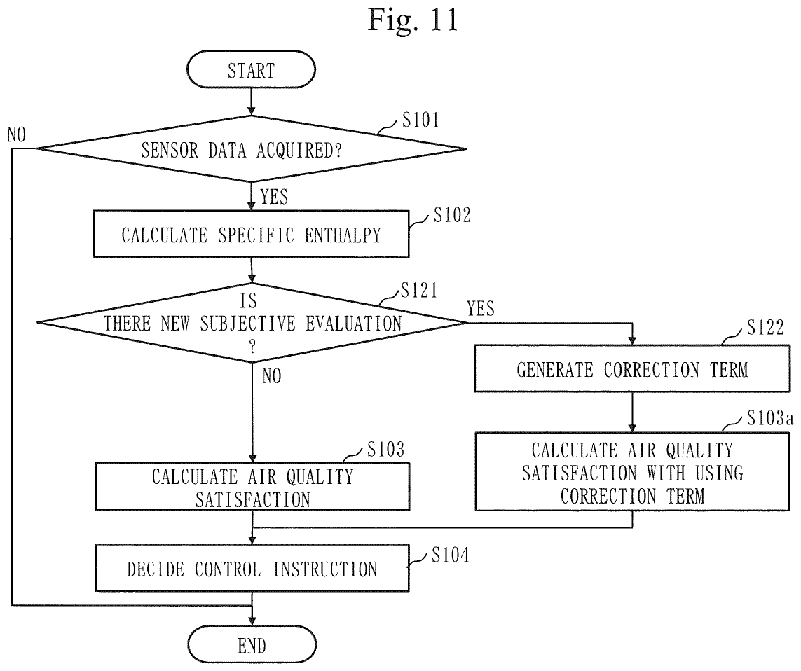

FIG. 11 is a flowchart illustrating an operation example of the satisfaction calculation device 10 according to the present embodiment.

Processes of step S101, step S102, and step S103 in FIG. 11 are the same as the processes of step S101, step S102, and step S103 in FIG. 3 or 7. A process of step S104 is the same as the process of step S104 in FIG. 7.

<Check on Whether there is New Subjective Evaluation or not: Step S121>

The subjective evaluation input interface 970 acquires the subjective evaluation 34 from the subjective evaluation input device 70 and stores the acquired subjective evaluation 34 to the storage unit 130.

The satisfaction index generation unit 150 determines whether or not a new subjective evaluation 34 is added to the storage unit 130.

If a new subjective evaluation 34 is added, the processing proceeds to step S122.

If a new subjective evaluation 34 is not added, the processing proceeds to step S103. An air quality satisfaction is calculated in the same manner as in the processing described Embodiment 1 or 2.

### <Satisfaction Index Generation Process: Step S122>

The satisfaction index generation unit 150 acquires the new subjective evaluation 34 stored in the storage unit 130, and a temperature, a humidity, and a carbon dioxide concentration which are measured when the new subjective evaluation 34 is acquired. The temperature, the humidity, and the carbon dioxide concentration are acquired from a thermometer 20, a humidity meter 30, and a CO2 meter 40 respectively when the new subjective evaluation 34 is acquired.

The satisfaction index generation unit 150 calculates a correction term f(h) of the air quality satisfaction on a basis of the new subjective evaluation 34 and the temperature, humidity, and carbon dioxide concentration which are measured when the new subjective evaluation 34 is acquired. Note that h denotes a specific enthalpy, and f expresses a function.

Specifically, this is as follows.

The satisfaction index generation unit 150 generates the correction term h (f) by a multiple regression analysis technique. Specifically, a history of the subjective evaluation 34, and a temperature, humidity, and carbon dioxide concentration corresponding to the history of the subjective evaluation 34 are accumulated in the storage unit 130. The satisfaction index generation unit 150 generates the correction term f(h) by the multiple regression analysis technique on a basis of the history of the subjective evaluation 34, the temperature, humidity, and carbon dioxide concentration corresponding to the history of the subjective evaluation 34, the new subjective evaluation 34, and the temperature, humidity, and carbon dioxide concentration corresponding to the new subjective evaluation 34.

Alternatively, the satisfaction index generation unit 150 may generate the correction term f(h) by a machine learning technique such as a convolutional neural network. The satisfaction index generation unit 150 generates a machine learning model on a basis of the history of the subjective evaluation 34, and the temperature, humidity, and carbon dioxide concentration which correspond to the history of the subjective evaluation 34. Then, the satisfaction index generation unit 150 generates the correction term f(h) from the new subjective evaluation 34, and the temperature, humidity, and carbon dioxide concentration which correspond to the new subjective evaluation 34 by the machine learning technique.

An air quality satisfaction calculation formula including the calculated correction term f(h) is indicated by the following Expression 3.

Air Quality Satisfaction S′=a*h+b+f(h) (Expression 3)
a, b: constant
Note that h, a, and b are the same as those explained in Embodiment 1.

### <Air Quality Satisfaction Calculation Process Using Correction Term: Step S103a>

The air quality satisfaction calculation unit 120 calculates an air quality satisfaction S′ with using Expression 3 containing the correction term f(h).

### Explanation of Effect of Present Embodiment

As described above, the satisfaction calculation system according to the present embodiment is provided with the subjective evaluation input interface and the satisfaction index generation unit, and corrects the calculation expression for the air quality environment satisfaction with using the subjective evaluation. Hence, the satisfaction calculation system according to the present embodiment achieves an effect of being able to calculate an air quality satisfaction that highly coincides with the subjectivity of the user in the relevant evaluation target space.

In above Embodiments 1 to 3, the individual units constituting the satisfaction calculation device are described as independent function blocks. However, the configuration of the satisfaction calculation device is not limited to those of the embodiments described above. The function blocks of the satisfaction calculation device may be of any configuration as far as they can implement the functions described in the above embodiments. The satisfaction calculation device need not be one device but may be a system constituted of a plurality of devices.

Of Embodiments 1 to 3, a plurality of portions may be practiced by combination. Alternatively, of these embodiments, one portion may be practiced. These embodiments may be practiced by any combination entirely or partially.

That is, in Embodiments 1 to 3, the individual embodiments can be combined freely; an arbitrary constituent element of each embodiment can be deformed; or an arbitrary constituent element in each embodiment can be omitted.

The embodiments described above are essentially preferred exemplifications and are not intended to limit the scope of the present disclosure, the scope of an applied product of the present disclosure, and the scope of use of the present disclosure. The embodiments described above can be modified in various manners as necessary. For example, the procedures described with using the flowcharts may be modified properly.

### REFERENCE SIGNS LIST

10: satisfaction calculation device; 20: thermometer; 30: humidity meter; 31: air quality satisfaction; 32: control information; 33: power consumption information; 34: subjective evaluation; 35: control instruction; 40: CO2 meter; 50: air conditioner; 60: ventilator; 70: subjective evaluation input device; 110: specific enthalpy calculation unit; 120: air quality satisfaction calculation unit; 130: storage unit; 131: threshold value; 140: control instruction decision unit; 150: satisfaction index generation unit; 200: controller; 500: satisfaction calculation system; 909: electronic circuit; 910: processor; 921: memory; 922: auxiliary storage device; 930: input interface; 940: output interface; 941: display unit; 950: communication device; 960: device control interface; 970: subjective evaluation input interface.

1. A satisfaction calculation device which calculates satisfaction with an air quality expressing an air environment of a space, the satisfaction calculation device comprising:
processing circuitry
to acquire a temperature and a humidity of the space and to calculate a specific enthalpy of the space, and
to acquire a carbon dioxide concentration of the space, to decide a constant that takes a different value in accordance with the carbon dioxide concentration, and to calculate satisfaction with the air quality as an air quality satisfaction by using the specific enthalpy and the constant.

2. The satisfaction calculation device according to claim 1,
wherein the processing circuitry decides, as the constant, a first constant by which the specific enthalpy is to be multiplied and a second constant which is to be added to a value obtained by multiplying the specific enthalpy by the first constant, and calculates, as the air quality satisfaction, a value obtained by adding the second constant to the value obtained by multiplying the specific enthalpy by the first constant.

3. The satisfaction calculation device according to claim 2, comprising
a memory to store a first threshold value and a second threshold value, as a threshold value of the carbon dioxide concentration,
wherein the processing circuitry decides the first constant and the second constant in accordance with which case the carbon dioxide concentration corresponds to, among: a case where the carbon dioxide concentration is lower than the first threshold value; a case where the carbon dioxide concentration is equal to or higher than the first threshold value and lower than the second threshold value; and a case where the carbon dioxide concentration is equal to or higher than the second threshold value.

4. The satisfaction calculation device according to claim 3, comprising
a display to display a display screen showing the air quality satisfaction.

5. The satisfaction calculation device according to claim 3, comprising
a video output interface to display the air quality satisfaction onto an external display device.

6. The satisfaction calculation device according to claim 3,
wherein the processing circuitry decides a control instruction to change control for a controller that influences the air quality.

7. The satisfaction calculation device according to claim 6,
wherein the memory stores a history of control information in the controller and a history of the air quality satisfaction in the controller, and holds information of a power consumption in accordance with a control content of the controller in advance, and
wherein the processing circuitry estimates a change amount of the air quality satisfaction resulting from control by the controller, from the history of the control information in the controller and the history of the air quality satisfaction, per control content for the controller, and decides a control content that can be achieved with a smallest power consumption increase, as the control instruction, among control contents that improve the air quality satisfaction from a current state by combination of the change amount of the air quality satisfaction with a power consumption of when the control contents are practiced.

8. The satisfaction calculation device according to claim 6,
wherein the memory stores a history of control information in the controller, a history of the air quality satisfaction, and a history of power consumption information in the controller, and
wherein the processing circuitry estimates a change amount of the air quality satisfaction caused by the control instruction, and a power consumption increase caused by the control instruction, by using the history of the control information, the history of the air quality satisfaction, and the history of the power consumption information, and decides a control content that can be achieved with a smallest power consumption increase, as the control instruction, among control contents that improve the air quality satisfaction from a current state.

9. The satisfaction calculation device according to claim 7,
wherein, in a situation where a manipulation is inputted to the controller, the satisfaction calculation device does not decide the control instruction for a device to which the manipulation is inputted in the controller, and decides the control instruction for a device to which a manipulation is not inputted in the controller.

10. The satisfaction calculation device according to claim 1, comprising:
a subjective evaluation input interface to accept input of a subjective evaluation about the air quality satisfaction,
wherein the processing circuitry generates a correction term to be used for calculating the air quality satisfaction on a basis of the subjective evaluation.

11. The satisfaction calculation device according to claim 10,
wherein the processing circuitry generates the correction term by a multiple regression analysis technique.

12. The satisfaction calculation device according to claim 10,
wherein the processing circuitry generates the correction term by a machine learning technique.

13. A satisfaction calculation method employed by a satisfaction calculation device which calculates satisfaction with an air quality expressing an air environment of a space, the satisfaction calculation method comprising:
acquiring a temperature and a humidity of the space and calculating a specific enthalpy of the space; and
acquiring a carbon dioxide concentration of the space, deciding a constant that takes a different value in accordance with the carbon dioxide concentration, and calculating satisfaction with the air quality as an air quality satisfaction by using the specific enthalpy and the constant.

14. A non-transitory computer readable medium storing a satisfaction calculation program employed by a satisfaction calculation device which calculates satisfaction with an air quality expressing an air environment of a space, the satisfaction calculation program comprising:
a specific enthalpy calculation process of acquiring a temperature and a humidity of the space and calculating a specific enthalpy of the space; and
an air quality satisfaction calculation process of acquiring a carbon dioxide concentration of the space, deciding a constant that takes a different value in accordance with the carbon dioxide concentration, and calculating satisfaction with the air quality as an air quality satisfaction by using the specific enthalpy and the constant.
